(19) United States
(12) Patent Application Publication
(10) Pub. No.: US 2019/0278714 A1
(43) Pub. Date: Sep. 12, 2019

(54) SYSTEM AND METHOD FOR MEMORY ACCESS LATENCY VALUES IN A VIRTUAL MACHINE

(71) Applicant: Nutanix, Inc., San Jose, CA (US)

(72) Inventors: Gaurav Poothia, Redmond, WA (US); Alexander J. Kaufmann, San Jose, CA (US)

(21) Appl. No.: 15/916,812

(22) Filed: Mar. 9, 2018

(51) Int. Cl. G06F 12/109; G06F 12/06; G06F 9/50; G06F 9/455

(52) U.S. Cl. CPC G06F 12/109; G06F 12/06; G06F 9/5077; G06F 2009/45583; G06F 2212/2542; G06F 2212/657; G06F 9/45558

(57) ABSTRACT

A system and method include obtaining, by a computing system, mapping information mapping a plurality of virtual processors and a plurality of virtual memories included in the computing system to a plurality of physical processors and a plurality of physical memories in a physical resource, the plurality of physical processors having non-uniform memory access times to the plurality of physical memories. The system and method also include obtaining a first set of latency values associated with the non-uniform memory access times between the plurality of physical processors and the plurality of physical memories. The system and method further include generating a second set of latency values associated with access times between the plurality of virtual processors and the plurality of virtual memories based on the mapping information and the first set of latency values.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, present day virtual computing systems still have limitations due to their configuration and the way they operate.

### SUMMARY

In accordance with at least some aspects of the present disclosure, a method is disclosed. The method includes obtaining, by a computing system, mapping information mapping a plurality of virtual processors and a plurality of virtual memories included in the computing system to a plurality of physical processors and a plurality of physical memories in a physical resource, the plurality of physical processors having non-uniform memory access times to the plurality of physical memories. The method further includes obtaining, by a computing system, a first set of latency values associated with the non-uniform memory access times between the plurality of physical processors and the plurality of physical memories. The method also includes generating, by the computing system, a second set of latency values associated with access times between the plurality of virtual processors and the plurality of virtual memories based on the mapping information and the first set of latency values.

In accordance with some other aspects of the present disclosure, a system is disclosed. The system includes a physical processing resource including a plurality of physical processors and a plurality of physical memories; the plurality of physical processors having non-uniform memory access times to the plurality of physical memories. The system also includes a virtual machine including a plurality of a plurality of virtual processors and a plurality of virtual memories. The virtual machine is configured to obtain mapping information mapping the plurality of virtual processors and the plurality of virtual memories to the plurality of physical processors and the plurality of physical memories. The virtual machine is further configured to obtain a first set of latency values associated with the non-uniform memory access times between the plurality of physical processors and the plurality of physical memories. The virtual machine is also configured to generate a second set of latency values associated with access times between the plurality of virtual processors and the plurality of virtual memories based on the mapping information and the first set of latency values.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 shows a block diagram of a node 200 used in a virtual computing system, in accordance with some embodiments of the present disclosure.

FIG. 3 shows an example physical latency table that specifies latencies between physical processing cores and physical memory banks in the hardware resources of the node shown in FIG. 2, in accordance with some embodiments of the present disclosure.

FIG. 4 shows an example first virtual latency table that specifies latencies between virtual processing cores and virtual memory banks in a virtual machine, in accordance with some embodiments of the present disclosure.

FIG. 5 shows an example second virtual latency table that specifies latencies between virtual processing cores and virtual memory banks in a virtual machine, in accordance with some embodiments of the present disclosure.

FIG. 6 shows a flow diagram of an example process for executing a virtual machine based on a virtual non-uniform memory access architecture, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to operating one or more virtual machines in a computing system including non-uniform memory access (NUMA) physical resource architecture. The NUMA architecture includes one or more physical processing nodes, where each physical processing node includes one or more physical processing cores and one or more physical memory banks. The physical processing cores can have non-uniform access times to the one or more memory banks. The virtual machines include at least one virtual processing node, where each virtual processing node includes virtual processing cores and virtual memory banks.

One technical problem encountered in such computing systems is the lack of latency information associated with virtual processing cores and virtual memory banks available at the virtual machine. The NUMA architecture at the physical level can have non-uniform latencies or access times between the physical processing cores and the physical memory banks. A hypervisor can map virtual processing cores and virtual memory banks to physical processing cores and physical memory banks. Thus, there can be non-uniform latencies between virtual processing cores and virtual memory banks. Some virtual machines may not have the ability to provide latency information or may provide uniform latencies to the operating system. As a result, process or thread scheduling by the operating system on the virtual processing cores and the virtual memory banks may become inefficient or unpredictable, and may affect the performance of the computing system.

The discussion below provides at least one technical solution to the technical problems mentioned above. For example, the computing system discussed below, the virtual processing cores also can be configured to have non-uniform access times to the virtual memory banks. That is, the virtual machine is configured to include a virtual NUMA architecture. The virtual machine is configured to obtain latency information associated with the physical processing nodes, and generate latency information associated with the virtual processing nodes based on the latency information associated with the physical processing nodes and mapping information between the virtual processing nodes and the physical processing nodes. The virtual machine can provide the generated latency information to the operating system. In turn, the operating system can assign processes and threads to virtual processing cores and virtual memory banks based, in part, on the latency information. Thus, the operating system can schedule processes or threads to appropriate virtual processing cores and memory banks to reduce execution time, or improve throughput.

The virtual machine can obtain the latency times associated with the physical processing nodes from a hypervisor. The virtual machine can be configured to update the latency times associated with the virtual processing nodes if changes in the mapping information or changes in the latency times associated with the physical processing nodes is detected.

Providing and updating the latency information for the virtual processing nodes allows the virtual machine or the operating system running on the virtual machine to schedule, assign, or allocate virtual processing cores and virtual memory banks based on the current latency information. As such, the operating system can assign and reassign processes and threads to improve execution times and throughput of the computing system.

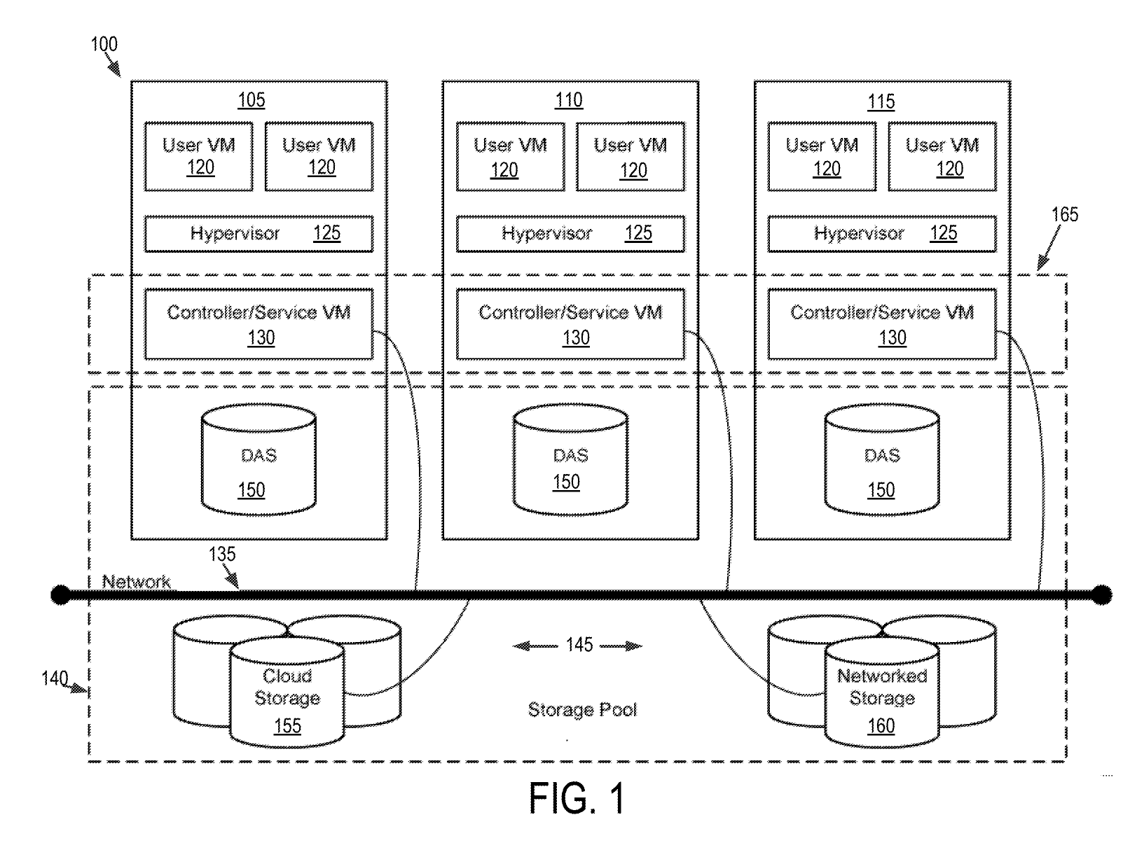

Referring now to FIG. 1, a virtual computing system 100 is shown, in accordance with some embodiments of the present disclosure. The virtual computing system 100 may be part of a datacenter. The virtual computing system 100 includes a plurality of nodes, such as a first node 105, a second node 110, and a third node 115. Each of the first node 105, the second node 110, and the third node 115 includes user virtual machines (VMs) 120 and a hypervisor 125 configured to create and run the user VMs. Each of the first node 105, the second node 110, and the third node 115 also includes a controller/service VM 130 that is configured to manage, route, and otherwise handle workflow requests to and from the user VMs 120 of a particular node. The controller/service VM 130 is connected to a network 135 to facilitate communication between the first node 105, the second node 110, and the third node 115. Although not shown, in some embodiments, the hypervisor 125 may also be connected to the network 135.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the first node 105, the second node 110, and the third node 115, such that each of the first, second, and third nodes may access its respective direct-attached storage without having to access the network 135.

It is to be understood that only certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater or fewer than three nodes may be used. Likewise, although only two of the user VMs 120 are shown on each of the first node 105, the second node 110, and the third node 115, in other embodiments, the number of the user VMs on the first, second, and third nodes may vary to include either a single user VM or more than two user VMs. Further, the first node 105, the second node 110, and the third node 115 need not always have the same number of the user VMs 120. Additionally, more than a single instance of the hypervisor 125 and/or the controller/service VM 130 may be provided on the first node 105, the second node 110, and/or the third node 115.

Further, in some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100.

Each of the first node 105, the second node 110, and the third node 115 may also be configured to communicate and share resources with each other via the network 135. For example, in some embodiments, the first node 105, the second node 110, and the third node 115 may communicate and share resources with each other via the controller/service VM 130 and/or the hypervisor 125. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective first node 105, the second node 110, and the third node 115 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the first node 105, the second node 110, and the third node 115 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the first node 105, the second node 110, and the third node 115) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the first node 105, the second node 110, third node 115) to run multiple instances of the user VMs 120, with each user VM sharing the resources of that one physical server computer, potentially across multiple environments. By running the plurality of user VMs 120 on each of the first node 105, the second node 110, and the third node 115, multiple workloads and multiple operating systems may be run on a single piece of underlying hardware computer (e.g., the first node, the second node, and the third node) to increase resource utilization and manage workflow.

The user VMs 120 are controlled and managed by the controller/service VM 130. The controller/service VM 130 of each of the first node 105, the second node 110, and the third node 115 is configured to communicate with each other via the network 135 to form a distributed system 165. The hypervisor 125 of each of the first node 105, the second node 110, and the third node 115 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the first node 105, the second node 110, and the third node 115. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 140 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120 that are part of a cluster may be configured to share resources with each other.

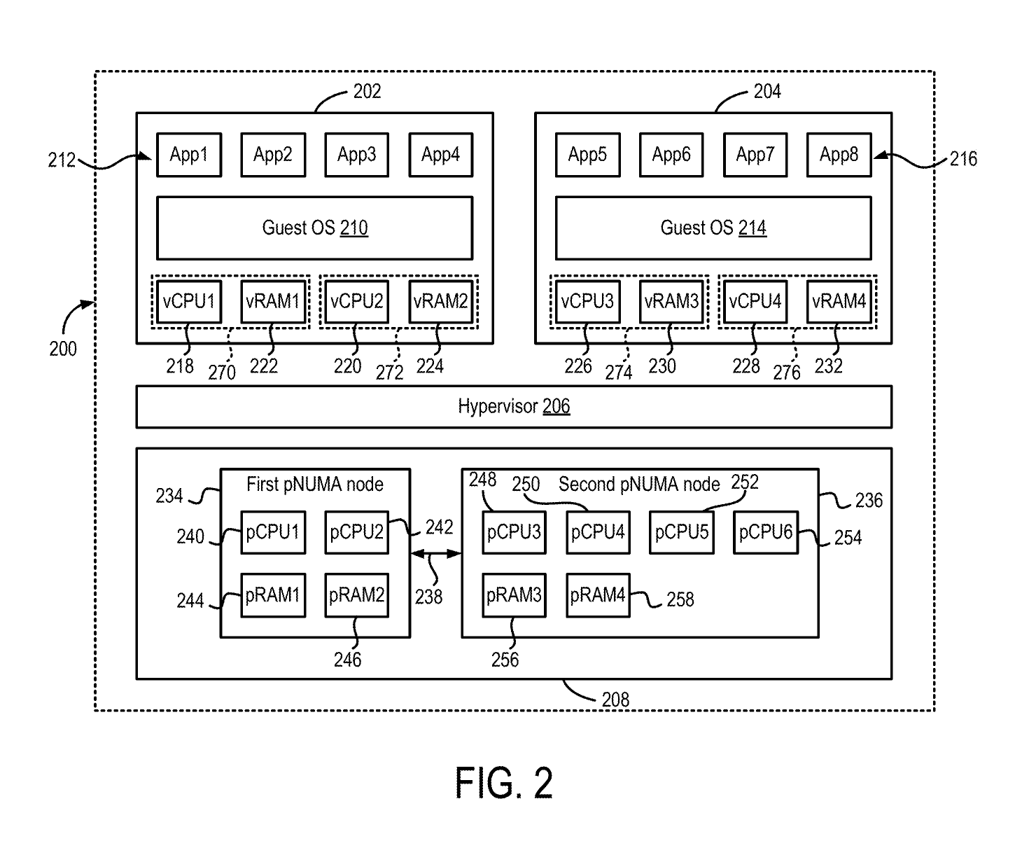

FIG. 2 shows a block diagram of a node 200 used in a virtual computing system, in accordance with some embodiments of the present disclosure. The node 200 shown in FIG. 2, for example, can be used to implement one or more of the first node 105, the second node 110, and the third node 115 discussed above in relation to FIG. 1. The node 200 includes a first user VM 202, a second user VM 204, a hypervisor 206, and physical hardware resources 208. The first user VM 202 and the second user VM 204 can be similar to the user VMs 120 discussed above in relation to FIG. 1. In addition, the first user VM 202 can include a first guest operating system (OS) 210 that can run a first set of software applications 212 (App1, App2, App3, and App4). Similarly, the second user VM 204 can include a second guest OS 214 that can run a second set of applications 216 (App5, App6, App7, and App8). The number of software applications in the first and the second set of software applications 212 and 216 shown in FIG. 2 are only examples, and that the respective guest OSs may run fewer or more software applications.

The first user VM 202 also can include one or more virtual processors (vCPUs) and virtual memories (vRAMs) provided by the hypervisor 206. For example, the first user VM 202 can include a first virtual CPU (vCPU1) 218 and a second virtual CPU (vCPU2) 220, a first virtual RAM (vRAM1) 222, and a second virtual RAM (vRAM2) 224. Similarly, the second user VM 204 can include a third virtual CPU (vCPU3) 226, a fourth virtual CPU (vCPU4) 228, a third virtual RAM (vRAM3) 230, and a fourth virtual RAM (vRAM4) 232. The first guest OS 210 can run the first set of software applications 212 on one or more of the virtual CPUs and virtual RAMs included in the first user VM 202. Similarly, the second guest OS 214 can run the second set of software applications 216 on one or more of the virtual CPUs and the virtual RAMs included in the second user VM 204. In particular, the guest OSs can schedule threads associated with the respective software applications to the one or more respective virtual CPUs and assign memory space to the threads on the one or more respective RAMs.

The hypervisor 206 can implement processor and memory virtualization by abstracting the hardware resources 208 including processors, memory, and I/O devices, and present the abstraction to the first and the second user VMs 202 and 204 as the virtual CPUs and RAMs. For example, the hypervisor 206 can implement processor virtualization by scheduling time slots on one or more physical processors of the hardware resources 208 such that from the guest OS's perspective, the time slots are scheduled on the virtual CPUs. The hypervisor 206 can implement memory virtualization by maintaining a translation table that translates virtual memory addresses assigned by the guest OSs to physical memory addresses in the physical memories of the hardware resources 208.

The hardware resources 208 can include several processors and memories. While not shown in FIG. 2, the hardware resources may also include one or more I/O resources which can be virtualized and presented as virtual I/O resources to the first and the second user VMs 202 and 204. The processors and the memories in the hardware resources 208 are structured in a form that supports non-uniform memory access (NUMA) architecture. In particular, the hardware resources 208 can be structured as a physical NUMA (pNUMA). The pNUMA can include several NUMA nodes, such as first pNUMA node 234 and a second pNUMA node 236 interconnected by an interconnect 238. The hardware resources 208 can represent a multi-socket processing board where each socket corresponds to a pNUMA node, and each pNUMA node includes multiple processing cores. For example, the first pNUMA node 234 can have processor socket including two CPU cores pCPU1 240 and pCPU2 242, and two memory banks pRAM1 244 and pRAM2 246, while the second pNUMA node 236 can have a processor socket including four CPU cores pCPU3 248, pCPU4 250, pCPU5 252, and pCPU6 254 and two memory banks pRAM3 256 and pRAM4 258. Within each pNUMA node, the CPU cores can access the respective memory banks over a bus, a crossbar, or other interconnection technology. However, the CPU cores in each pNUMA node can access memory banks in other pNUMA cores. For example, the pCPU1 240 can access pRAM3 256 in the second pNUMA node 236 via the interconnect 238, which can be a system bus, a crossbar, or other interconnect technology. The access time for a CPU core in one NUMA node to access a memory bank in different NUMA node can be greater than the access time for the CPU core to access a memory bank within the same NUMA node. Similarly, based on how the CPU cores and memory banks are interconnected within a NUMA node, the access time of a CPU core to one memory bank within the NUMA node can be different from the access time to another memory bank in the same NUMA node. Thus, the access latencies within and across the NUMA nodes can be non-uniform.

The hypervisor 206 can advantageously use the non-uniform latencies between various pCPU cores and pRAM banks in the hardware resources 208 in processor and memory virtualization. In particular, the hypervisor may map vCPUs to pCPUs and vRAMs to pRAMs based on the known latencies between the pCPUs and the pRAMs. For example, the hypervisor 206 may run critical applications on pCPUs and pRAMs pairs having the lowest latencies.

Referring again to the first user VM 202 and the second user VM 204, the virtual processors and the virtual memory within these virtual machines also can be structured in a non-uniform memory access architecture. For example, the hypervisor 206 can present the virtual machines a virtual NUMA (or vNUMA) architecture, where the various vCPUs and vRAMs are presented to the respective guest OS as being part of vNUMA nodes. For example, the hypervisor 206 can present the first guest OS 210 two vNUMA nodes, where the first vNUMA node 270 includes the vCPU1 218 and the vRAM1 222, while the second vNUMA node 272 includes the vCPU2 220 and the vRAM2 224. Similarly, the hypervisor 206 can be present the second guest OS 214 a third and fourth vNUMA nodes, where the third vNUMA node 274 includes the vCPU3 226 and the vRAM3 230, while the fourth vNUMA node 276 can include the vCPU4 228 and the vRAM4 232. The respective guest OSs, given the vNUMA architecture, can then schedule and map their respective applications based on the latencies between the various vCPUs and vRAMs provided by the hypervisor 206. The hypervisor 206 can maintain a physical latency table (also referred to as a physical system locality information table (pSLIT)) that specifies the latencies between any CPU core and a RAM bank.

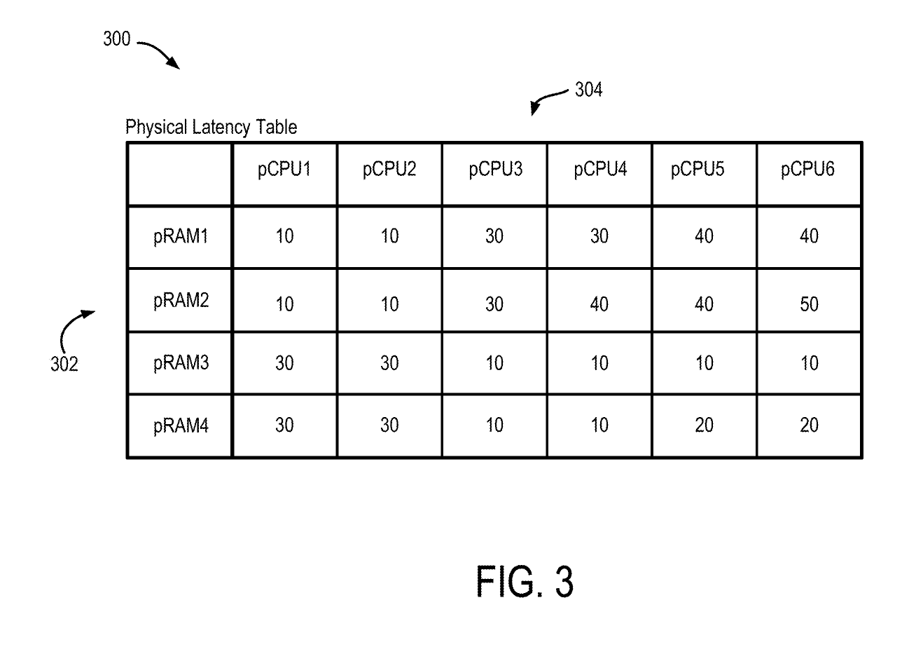

FIG. 3 shows an example physical latency table 300 that specifies latencies between physical CPU cores and physical RAM banks in the hardware resources 208. The physical latency table 300 includes four rows 302, each of the four rows corresponding to one of the four physical RAM banks: pRAM1 244, pRAM2 246, pRAM3 256, and pRAM4 258. The physical latency table 300 also includes six columns 304, each of the six columns corresponding to one of the six pCPU cores: pCPU1 240, pCPU2 242, pCPU3 248, pCPU4 250, pCPU5 252, and pCPU6 254. The physical latency table 300 specifies the latencies between pairs of physical CPU cores and physical RAM banks. For example, the latency for accessing the pRAM1 224 from the pCPU1 240 is 10, while the latency for accessing the pRAM1 244 from the pCPU5 252 is 40. The numbers representing latency are only examples, and can include units of time such as, for example, pico-seconds, nano-seconds, micro-seconds, etc. However, the latency may also be represented as a unit-less ratio. It should be understood that the latencies within the physical latency table 300 are based on the particular NUMA architecture, and can depend, in part, upon interconnect speeds between the CPU cores and the RAM banks in the hardware resources 208.

A similar latency table (also referred to as a virtual system locality information table (vSLIT)) can be maintained by the virtual machines specifying the access latencies between pairs of virtual CPUs and virtual RAM banks. For example, as discussed above, the hypervisor 206 can present to the first and second user VMs 202 and 204 a virtual NUMA architecture. The first and second VMs can maintain a virtual latency table specifying the access latencies between pairs of virtual CPUs and RAM banks.

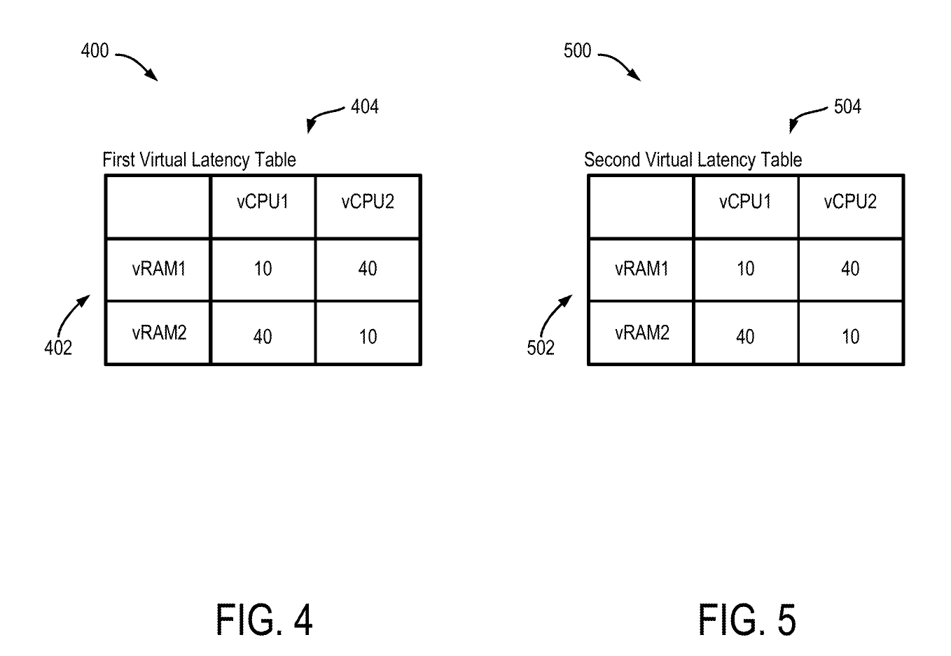

FIG. 4 shows an example first virtual latency table 400 that specifies latencies between virtual CPU cores and virtual RAM banks in a virtual machine. In particular, the first virtual latency table 400 can include latencies associated with the first user VM 202. The first virtual latency table 400 corresponds to and example vNUMA architecture including two vNUMA nodes, where the first vNUMA node includes the vCPU1 218 and the vRAM1 222, while the other vNUMA node includes the vCPU2 220 and the vRAM2 224. The first virtual latency table 400 includes two rows 402, each of the two rows corresponding to one of the two virtual RAM banks: vRAM1 222 and vRAM2 224. The first virtual latency table 400 also includes two columns 404, each of the two columns corresponding to one of the two vCPU cores: vCPU1 218 and vCPU2 220. The first virtual latency table 400 specifies the latencies between pairs of virtual CPU cores and virtual RAM banks in the first user VM 202. For example, the latency for accessing the vRAM1 222 from the vCPU1 218 is 10, while the latency for accessing the vRAM1 222 from the vCPU2 220 is 40. It is understood that the number of entries in the first virtual latency table 400 can be different based on the number of virtual CPU cores and the number of virtual RAM banks included in the first user VM 202. In addition, the latency values can vary based on the number of vNUMA nodes included in the first user VM 202 and the specific implementation of the vNUMA nodes. The first virtual latency table can be maintained by the first user VM 202 and/or the first guest OS 210.

FIG. 5 shows an example second virtual latency table 500 that specifies latencies between virtual CPU cores and virtual RAM banks in a virtual machine. In particular, the second virtual latency table 500 can include latencies associated with the second user VM 204. The second virtual latency table 500 corresponds to and example vNUMA architecture including two vNUMA nodes, where the third vNUMA node includes the vCPU3 226 and the vRAM3 230, while the fourth vNUMA node includes the vCPU4 228 and the vRAM4 232. The second virtual latency table 500 includes two rows 502, each of the two rows corresponding to one of the two virtual RAM banks: vRAM3 230 and vRAM4 232. The second virtual latency table 500 also includes two columns 504, each of the two columns corresponding to one of the two vCPU cores: vCPU3 226 and vCPU4 228. The second virtual latency table 500 specifies the latencies between pairs of virtual CPU cores and virtual RAM banks in the second user VM 204. For example, the latency for accessing the vRAM3 230 from the vCPU3 218 is 10, while the latency for accessing the vRAM3 230 from the vCPU4 228 is 40. Similar to the first virtual latency table 400, it is understood that the number of entries in the second virtual latency table 500 can be different based on the number of virtual CPU cores and the number of virtual RAM banks included in the second user VM 204. In addition, the latency values can vary based on the number of vNUMA nodes included in the second user VM 204 and the specific implementation of the vNUMA nodes. The second virtual latency table can be maintained by the second user VM 204 and/or the second guest OS 214.

The first and the second user VMs 202 and 204 can populate the latency values in their respective virtual latency tables based on latency values included in the physical latency table 300. In particular, the hypervisor 206 can provide the first and second user VMs 202 and 204 with the latency values included in the physical latency table 300. For example, the operating systems running on the first and second user VMs 202 and 204 can use advanced configuration and power interface (ACPI) to request the physical latency information from the hypervisor 206 or the hardware resources 208. The first and second user VMs 202 and 204 can then utilize the current mapping of vCPUs to pCPUs and vRAMs to pRAMs to determine the appropriate latency values for their respective virtual latency tables. For example, referring to FIG. 2, assume that the hypervisor 206 maps the vCPU1 218 and vRAM1 222 of the first vNUMA node 270 to the pCPU1 240 and the pRAM1 244, respectively, of the first pNUMA node 234. Further, the hypervisor 206 maps the vCPU2 220 and the vRAM2 224 of the second vNUMA node 272 to the pCPU3 248 and the pRAM3 256, respectively, of the second pNUMA node 236. The first user VM 202 can request from the hypervisor 206 the latencies included in the physical latency table 300. Based on the mapping of the virtual CPUs and virtual RAMs to the physical CPUs and physical RAMs and the latency values included in the physical latency table, the first user VM 202 can populate the latency values in the first virtual latency table 400. For example, the latency value corresponding to the vCPU1 218 and the vRAM1 222 can correspond to the latency between the physical CPU and physical RAM to which the vCPU1 218 and the vRAM1 222 are mapped. As mentioned in the example above, the vCPU1 218 and the vRAM1 222 are mapped to the pCPU1 240 and the pRAM1 244, respectively, of the first pNUMA node 234. As shown in FIG. 3, the latency value corresponding to the pCPU1 240 and the pRAM1 244 in the physical latency table 300 is 10. Therefore, the first user VM 202 can populate the entry in the first virtual latency table 400 corresponding to the vCPU1 218 and the vRAM1 222 with the latency value 10. The first user VM 202 can populate the latency values of other entries in the first virtual latency table 400 in a similar manner.

It should be noted that the vNUMA and pNUMA architecture shown in FIG. 2 is only an example, and that other configuraitons are also within the scope of this disclosure. In one or more embodiments, each pNUMA node, such as the first pNUMA node 234 and the second pNUMA node 236 shown in FIG. 2, can include only a single pRAM per node, instead of the two pRAMs shown in FIG. 2. In such instances, several pCPU cores share the same pRAM bank and may have substantially equal latencies to that pRAM bank. Similarly, the vNUMA nodes may also include only a single vRAM instead of the two vRAMs shown in FIG. 2. In one or more embodiments, the vNUMA structure can mirror the pNUMA structure provided by the physical hardware resources 208. For example, the number of vCPU cores and vRAM banks in a vNUMA node can be equal to the pCPU cores and pRAM banks in the pNUMA.

In some implementations, first user VM 202 may populate the first virtual latency table 400 with latency values that are a function of the latency value selected from the physical latency table 300. For example, the function can include one or more of a factor, a multiplier, an offset, or any other mathematical function. For example, the first user VM 202 may multiply the latency value selected from the physical latency table 300 by a multiplication factor and populate the first virtual latency table 400 with the result. In another example, the first user VM 202 may offset the latency value selected from the physical latency table 300 and use the resulting value to populate the first virtual latency table 400. The second user VM 204 can populate the second virtual latency table 500 shown in FIG. 5 in a manner similar to that discussed above in relation to the first user VM 202.

In one or more embodiments, the first and the second user VMs 202 and 204 may update the latency values in their respective virtual latency tables. For example, the virtual machine may update the latency values in response to changes in the mapping of the virtual CPUs and virtual RAM banks to the physical CPUs and physical RAM banks. In another example, the virtual machine may update the latency values in the virtual latency table in response to changes in the latency values in the physical latency table 300. In one or more embodiments, the first and the second user VMs 202 and 204 may repeatedly communicate with the hypervisor 206 to obtain the current mappings and the current latency values in the physical latency table, and determine and update if necessary, the latency values in their respective virtual latency tables. In one or more embodiments, the first and second user VMs 202 and 204 can receive an indication from the hypervisor 206 if there is any change in the mappings or any change in one or more latency values in the physical latency table 300. The indication may also include the updated mappings and the updated latency values. In response, the first and the second user VMs 202 and 204 can update, if necessary, the latency values in their respective virtual latency tables.

As discussed above, the hypervisor 206 can maintain the mappings of the vCPUs and the vRAMs to the pCPUs and the pRAMs in a mapping data structure. The hypervisor 206 can communicate the mapping data structure to the first and the second user VMs 202 and 204 so that the mapping information can be used to update the virtual latency tables. In one or more embodiments, the mapping data structure can include a table that lists identifiers (such as a name or a unique ID) associated with the vNUMA nodes, and the identifiers of the pNUMA nodes to which each of the vNUMA nodes are mapped. For example, referring to FIG. 2, the first vNUMA node 270 is mapped to the first pNUMA node 234. The table can include the identity of the first vNUMA node 270 in association with an identity of the first pNUMA node 234. The table (or another table) can additionally include a list of identfiiers of vCPU cores and vRAM banks and the identifers of the mapped pCPU cores and pRAM banks. For example, the table can include identities of the vCPU1 218, the vRAM1 222, the vCPU2, and the vRAM2 224 and the associated pCPUs and pRAMs in the first pNUMA node 234. The mapping data structure can similarly include the mapping information between all the vNUMA nodes and the associated pNUMA nodes, including the mapping information between individual vCPUs/vRAMs and the pCPUs/pRAMs. In one or more embodiments, the hypervisor 206 can first map a vNUMA node to a pNUMA node, and then map the vCPU cores and vRAM banks to pCPU cores and pRAM banks.

The first and the second user VMs 202 and 204, by maintaining the first and second virtual latency tables 400 and 500 can leverage the vNUMA architecture and the associated non-uniform latency values to assign the first and second set of applications 212 and 216 to the appropriate virtual CPUs and virtual RAM banks. For example, if App1 were a critical application or an application requiring a high quality of service, the first user VM 202 may assign the App1 (or the associated program threads) to the virtual CPU and virtual RAM bank pair having the lowest latency value. As another example, the first user VM 202 may assign program threads associated with a database application analyzing data sets, which may include repeated memory access, may be assigned, to a virtual CPU and virtual RAM bank pair having a low latency value.

For example, referring to the first virtual latency table 400, the first user VM 202 may assign the App1 to either vCPU1 218 and the vRAM1 222 or to vCPU2 220 and the vRAM2 224. In some other embodiments, the first user VM 202 may move an application or a program thread from a low latency pair of vCPU and vRAM to a high latency pair of vCPU and vRAM if, for example, it is determined that the frequency of the thread's access to the vRAM is low enough to justify high latecy. The first user VM 202 may then assign another application or thread to the low latency pair of vCPU and vRAM. This can be of particular benefit in multithreading and multi-tasking scenarios, and can improve the performance of the virtual computing system 100.

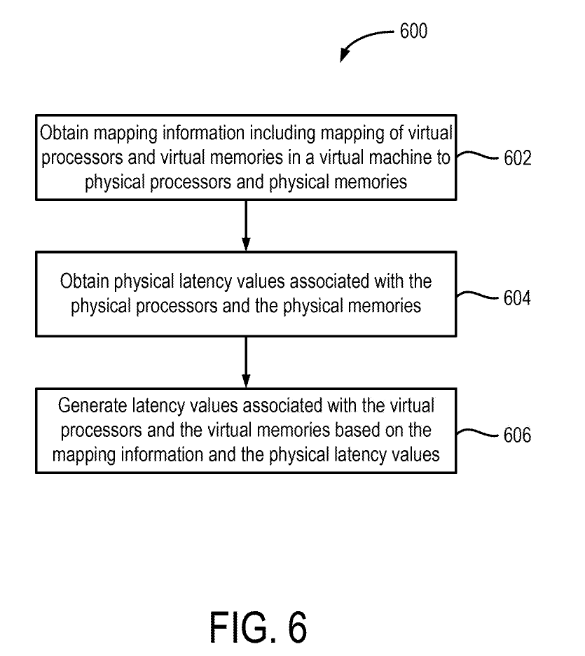

FIG. 6 shows a flow diagram of an example process 600 for executing a virtual machine based on a virtual non-uniform memory access architecture. Additional, fewer, or different operations may be performed depending on the implementation. In one or more embodiments, the process 600 can be executed by the first or the second user VMs 202 and 204 shown in FIG. 2. In some other embodiments, the process 600 can be executed, at least in part, by the hypervisor 206 shown in FIG. 2. The process 600 includes obtaining mapping information including mapping of virtual processors and virtual memories in a virtual machine to physical processors and physical memories (602). At least one example of this operation is discussed above in relation to FIGS. 1-5. For example, as discussed above, the first user VM 202 can obtain mapping information from the hypervisor 206 that specifies the mapping between the vCPUs and the vRAMs of the first user VM 202 and the pCPUs and pRAMs of the physical hardware resources 208. In particular, the first user VM 202 can obtain the mapping information that maps the vCPU1 218, the vCPU2 220, the vRAM1 222, and the vRAM2 224 to the pCPUs and the pRAMs of the first pNUMA node 234 or the second pNUMA node 236.

The process 600 also includes obtaining physical latency values associated with the physical processors and the physical memories (604). At least one example of this operation has been discussed above in relation to FIGS. 1-5. For example, as shown in FIG. 3, the physical latency table 300 includes latency values associated with pairs of pCPUs and pRAMs. The physical latency table 300 specifies the latency values associated with the pCPUs and pRAMs of the first pNUMA node 234 and the second pNUMA node 236.

The process 600 further includes generating latency values associated with the virtual processors and the virtual memories based on the mapping information and the physical latency values (606). At least one example of this operation has been discussed above in relation to FIGS. 1-5. For example, FIG. 4 shows a first virtual latency table 400 including latency values associated with the vCPUs and the vRAMs of the first user VM 202 generated by the first user VM 202 based on the mapping information and the latency values included in the physical latency table 300. For example, the latency value for the vCPU1 218 to access the vRAM1 222 is based on the mapping of the vCPU1 218 and the vRAM1 222 to the pCPU1 240 and the pRAM1 244, respectively, and the latency value of 10 associated with the pCPU1 240 and the pRAM1 244 (in the physical latency table 300).

It should be noted that the vNUMA and pNUMA architecture shown in FIG. 2 is merely an example, and that other configuraitons are also within the scope of this disclosure. In one or more embodiments, each pNUMA node, such as the first pNUMA node 234 and the second pNUMA node 236 shown in FIG. 2, can include only a single pRAM per node, instead of the two pRAMs shown in FIG. 2. In such instances, several pCPU cores share the same pRAM bank and may have substantially equal latencies to that pRAM bank. Similarly, the vNUMA nodes may also include only a single vRAM instead of the two vRAMs shown in FIG. 2. In one or more embodiments, the vNUMA structure can mirror the pNUMA structure provided by the physical hardware resources 208. For example, the number of vCPU cores and vRAM banks in a vNUMA node can be equal to the pCPU cores and pRAM banks in the pNUMA.

It is to be understood that in some embodiments, any of the operations described herein may be implemented at least in part as computer-readable instructions stored on a computer readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
obtaining, by a computing system, mapping information mapping a virtual processor and a virtual memory to a physical processor and a physical memory, respectively wherein the physical processor has a non-uniform memory access time to the physical memory
obtaining, by the computing system, a first latency value associated with the non-uniform memory access time; and
generating, by the computing system, a second latency value associated with an access time between the virtual processor and the virtual memory based on the mapping information and the first latency value.

2. The method of claim 1, further comprising assigning, by the computing system, an application running on the computing system to the virtual processor and the virtual memory based on the second latency value.

3. The method of claim 2, further comprising assigning, by the computing system, the application running on the computing system to the virtual processor and the virtual memory on a frequency of virtual memory access by the application.

4. The method of claim 1, wherein the physical processor and the physical memory are included in two physical Non-Uniform Memory Access (pNUMA) nodes.

5. The method of claim 1, wherein the virtual processor and the virtual memory are included in two virtual Non-Uniform Memory Access (vNUMA) nodes.

6. (canceled)

7. The method of claim 1, wherein obtaining the mapping information includes obtaining the mapping information from a hypervisor.

8. The method of claim 1, further comprising updating, by the computing system, the second latency value responsive to determining a change in the mapping information and the first latency value.

9. A
virtual machine including a virtual processor and a virtual memory, wherein the virtual machine includes programmed instructions to:
obtain mapping information mapping the virtual processor and the virtual memory to a physical processor and a physical memory, respectively, wherein the physical processor has non-uniform memory access time to the physical memory,
obtain a first latency value associated with the non-uniform memory access time, and
generate a second latency value associated with an access time between the virtual processor and the virtual memory based on the mapping information and the first latency value.

10. The virtual machine of claim 9, further including programmed instructions to:
assign an application running on the virtual machine to the virtual processor and the virtual memory based on the second latency value.

11. The virtual machine of claim 10, further including programmed instructions to:
assign the application running on the virtual machine to the virtual processor and the virtual memory based on a frequency of virtual memory access by the application.

12. The virtual machine of claim 9, wherein the physical processor and the physical memory are included in two virtual Non-Uniform Memory Access (vNUMA) nodes.

13. The virtual machine of claim 9, wherein the virtual processor and the virtual memory are included in two virtual Non-Uniform Memory Access (vNUMA) nodes.

14. (canceled)

15. The virtual machine of claim 9, wherein the virtual machine obtains the mapping information from a hypervisor.

16. The virtual machine of claim 9, wherein the virtual machine updates the second latency value responsive to determining a change in one of the mapping information and the first latency value.

17. (canceled)

18. A non-transitory computer readable storage medium to store a computer program configured to execute a method comprising:
obtaining mapping information mapping a virtual processor and a virtual memory to a physical processor and a physical memory, respectively, wherein the physical processor has a non-uniform memory access time to the physical memory;
obtaining a first latency value associated with the non-uniform memory access time; and
generating a second latency value associated with an access time between the virtual processor and the virtual memory based on the mapping information and the first latency value.

19. The non-transitory computer readable storage medium of claim 18, the method further comprising, assigning an application running on the computing system to the virtual processor and the virtual memory based on the second latency value.

20. The non-transitory computer readable storage medium of claim 19, the method further comprising, assigning the application running on the computing system to the virtual processor and the virtual memory based on a frequency of virtual memory access by the application.

21. The non-transitory computer readable storage medium of claim 18, wherein the physical processor and the physical memory are included in two physical Non-Uniform Memory Access (pNUMA) nodes.

22. The non-transitory computer readable storage medium of claim 18, wherein the virtual processor and the virtual memory are included in two virtual Non-Uniform Memory Access (vNUMA) nodes.

23. The non-transitory computer readable storage medium of claim 18, wherein obtaining the mapping information includes obtaining the mapping information from a hypervisor.

24. The non-transitory computer readable storage medium of claim 18, the method further comprising updating the second latency value responsive to determining a change in the mapping information and the first latency value.
